(19) United States
(12) Patent Application Publication
(10) Pub. No.: US 2008/0073523 A1
(43) Pub. Date: Mar. 27, 2008

(54) Semiconductor wafer defect inspection method and apparatus

(75) Inventors: Naohiro Takahashi, Kawasaki (JP); Tamihide Yasumoto, Kawasaki (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: FUJITSU LIMITED, Kawasaki (JP)

(21) Appl. No.: 11/600,855

(22) Filed: Nov. 17, 2006

(30) Foreign Application Priority Data
Jul. 26, 2006 (JP) 2006-203347

(51) Int. Cl. G01N 23/00

(52) U.S. Cl. 250/307

(57) ABSTRACT

A semiconductor wafer whose position information on defects on a surface of the semiconductor wafer is already known, is placed on a stage of an imaging apparatus. Positions in a height direction of a plurality points on the surface of the semiconductor wafer are measured. In accordance with the measured positions in the height direction, the surface is partitioned into a plurality of partial areas. One partial area for which images of defects are still not acquired, is selected from the partial areas. The height of the stage is adjusted so as to set the selected partial area in an auto focusing range. Defects in the selected partial area are imaged with the imaging apparatus to acquire images of defects. Steps between the step of selecting the partial area and the step of acquiring the images of defects are repeated until images of defects in all partial areas are acquired.

### CROSS REFERENCE TO RELATED APPLICATION

This application is based on and claims priority of Japanese Patent Application No. 2006-203347 filed on Jul. 26, 2006, the entire contents of which are incorporated herein by reference.

### BACKGROUND OF THE INVENTION

A) Field of the Invention

The present invention relates to a defect inspection method and apparatus for inspecting a defect on the surface of a semiconductor wafer, and more particularly to a defect inspection method and apparatus in which an image of a plurality of defects whose positions are already known is acquired and image recognition is performed.

B) Description of the Related Art

In order to evaluate the quality of a wafer process, auto defect review (ADR) is performed by which defects generated on a surface of a semiconductor wafer during each wafer process are observed with a scanning electron microscope (SEM), auto defect classification (ADC) is performed by which defects are classified into various groups, or other approaches are performed. Description will be made on an auto defect review method disclosed in JP-A-2005-285746.

Prior to taking images of defects whose positions are already identified in a semiconductor wafer, focal positions of a plurality of points designated on the semiconductor wafer are obtained through manual adjustment. A curved plane approximating measurement results of these focal positions is estimated.

When images of defects are taken and if there is a point whose focal position has already been measured, near imaging target defects, focusing is performed by utilizing the measurement results of the focal positions at the already measured points. If there is no point whose focal position has already been measured near the imaging target, focusing is actually performed. In this case, since the curved plane approximating the focal position measurement results has already been estimated, the range of searching the focal position can be narrowed. The position of a defect for which focusing was performed is registered as a point whose focal position has been measured already.

In this manner, it is possible to shorten the time required for auto focusing.

### SUMMARY OF THE INVENTION

As the diameter of a semiconductor wafer becomes large, even a slight warpage leads to a large position shift in a height direction between a wafer central area and a wafer peripheral area. If this shift exceeds the range capable of auto focusing, auto focusing cannot be made either for a defect near the wafer central area or for a defect near the wafer peripheral area.

An object of the present invention is to provide a defect inspection method and apparatus capable of acquiring the images of defects by focusing all defects on a semiconductor wafer surface even if there is a warpage exceeding the auto focusing range.

The present inventors have proposed a defect inspection method comprising steps of:

(a) preparing a semiconductor wafer whose position information on defects on a surface of the semiconductor wafer is already known;

(b) placing the semiconductor wafer on a stage of an imaging apparatus;

(c) measuring positions in a height direction of a plurality points on the surface of the semiconductor wafer;

(d) partitioning the surface into a plurality of partial areas in accordance with the positions in the height direction measured by the step (c);

(e) selecting from the partial areas one partial area for which images of defects are still not acquired;

(f) adjusting a height of the stage so as to set the selected partial area in an auto focusing range of the imaging apparatus;

(g) imaging defects in the selected partial area with the imaging apparatus to acquire images of defects; and

(h) repeating the steps (e) to (g) until images of defects in all partial areas are acquired.

The present inventors have also proposed a defect inspection apparatus comprising:

a stage provided with a function of placing a semiconductor wafer thereon and displacing the placed semiconductor wafer in a height direction;

a height measuring device for measuring positions in the height direction of a plurality of points on a surface of the semiconductor wafer placed on the stage;

an imaging device for automatically focusing on a point positioned in an auto focusing range in the height direction and imaging defects on the surface of the semiconductor wafer placed on the stage to acquire images of defects; and

a controller storing position information on a plurality of defects on the surface of the semiconductor wafer placed on the stage,

wherein the controller controls the stage and the imaging device so as to execute steps of:

(a) partitioning the surface of the semiconductor wafer into a plurality of partial areas in accordance with positions in the height direction of the surface of the semiconductor wafer placed on the stage;

(b) selecting from the partial areas one partial area for which images of defects are still not acquired;

(c) adjusting a height of the stage so as to set the selected partial area in an auto focusing range of the imaging device;

(d) acquiring images of defects in the selected partial area with the imaging device; and

(e) repeating the steps (b) to (d) until images of defects in all partial areas are acquired.

As the surface of a semiconductor wafer is partitioned into a plurality of partial areas, the size in a height direction of the partial area is smaller than the size in the height direction of the whole surface. Images of defects are taken for each partial area so that it is possible to suppress generation of out-of-focus to be caused by being located outside the auto focusing range.

### BRIEF DESCRIPTION OF THE DRAWINGS

FIG. 1 is a schematic diagram of a defect inspection apparatus according to an embodiment.

FIG. 2A is a plan view of a semiconductor wafer, FIG. 2B is a cross sectional view of the semiconductor wafer, and FIGS. 2C and 2D are SEM photographs of a semiconductor wafer in an in-focus state and an out-of-focus state.

FIG. 3 is a table showing items stored in an adjustment date storage device.

FIG. 4 shows an image recognition rule table.

FIG. 5 is a flow chart illustrating a defect inspection method according to an embodiment.

FIG. 6 is a flow chart illustrating auto defect review according to an embodiment.

FIG. 7 is a flow chart illustrating an image recognition rule confirmation method according to an embodiment.

FIG. 8 is a flow chart illustrating an execution timing of auto defect review and auto defect classification according to an embodiment.

### DESCRIPTION OF THE PREFERRED EMBODIMENTS

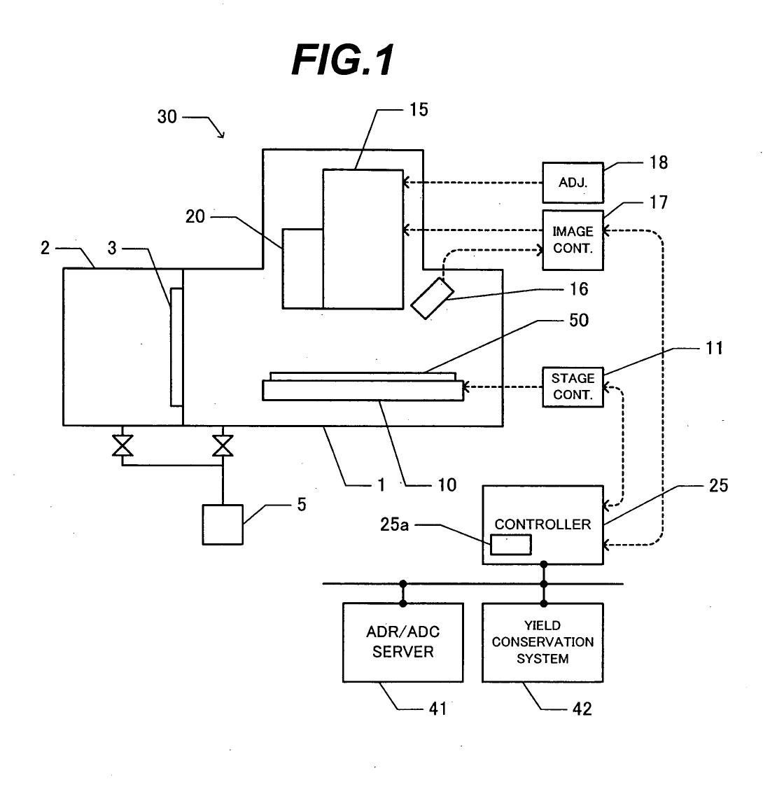

FIG. 1 is a schematic diagram of a defect inspection apparatus according to the embodiment. The defect inspection apparatus includes an imaging apparatus (specifically, a scanning electron microscope (SEM)) 30, an ADR/ADC server 41 and a yield conservation system 42.

The structure of SEM 30 will be described. A load lock chamber 2 is coupled to a sample chamber 1 via a gate valve 3. The inside of the sample chamber 1 and load lock chamber 2 is evacuated by a vacuum pump 5. A stage 10 on which a semiconductor wafer 50 is placed is disposed in the sample chamber 1. Under control of a stage controller 11, the stage 10 can displace the semiconductor wafer 50 in a height direction and can move the semiconductor wafer 50 in a two-dimensional direction parallel to the surface of the semiconductor wafer 50. The stage controller 11 controls the stage 10 in accordance with a control signal supplied from a controller 25.

An electron beam source 15, a secondary electron detector 16 and an optical microscope 20 are disposed above the stage 10. The optical microscope 20 can measure the position in a height direction of a point on the surface positioned in a visual field, by focusing the optical microscope on the surface of the semiconductor wafer 50 placed on the stage 10.

The electron beam source 15 includes an electron beam generator, a deflector, an electron lens and the like. The deflector deflects an electron beam emitted from the electron beam generator. The electron lens converges the electron beam. Under control of an image controller 17, the electron beam source 15 deflects the electron beam to scan the electron beam on the surface of the semiconductor wafer 50 in a two-dimensional direction. Further, the electron beam is converged (focused) to minimize the beam diameter of the electron beam on the surface of the semiconductor wafer 50.

If the surface of the semiconductor wafer 50 is positioned in the auto focusing range in the height direction, an auto focusing function operates to automatically focus the electron beam on the surface of the semiconductor wafer 50. The secondary electron detector 16 detects secondary electrons emitted from the semiconductor wafer 50, synchronously with scanning the electron beam. Detected results are converted into the images of defects by the image controller 17 and the image is input to the controller 25.

A dark field observation apparatus or the like observes beforehand the surface of the semiconductor wafer 50 placed on the stage 10 to detect defects on the surface and identify the positions of defects. Position data on defects are input to and stored in the controller 25.

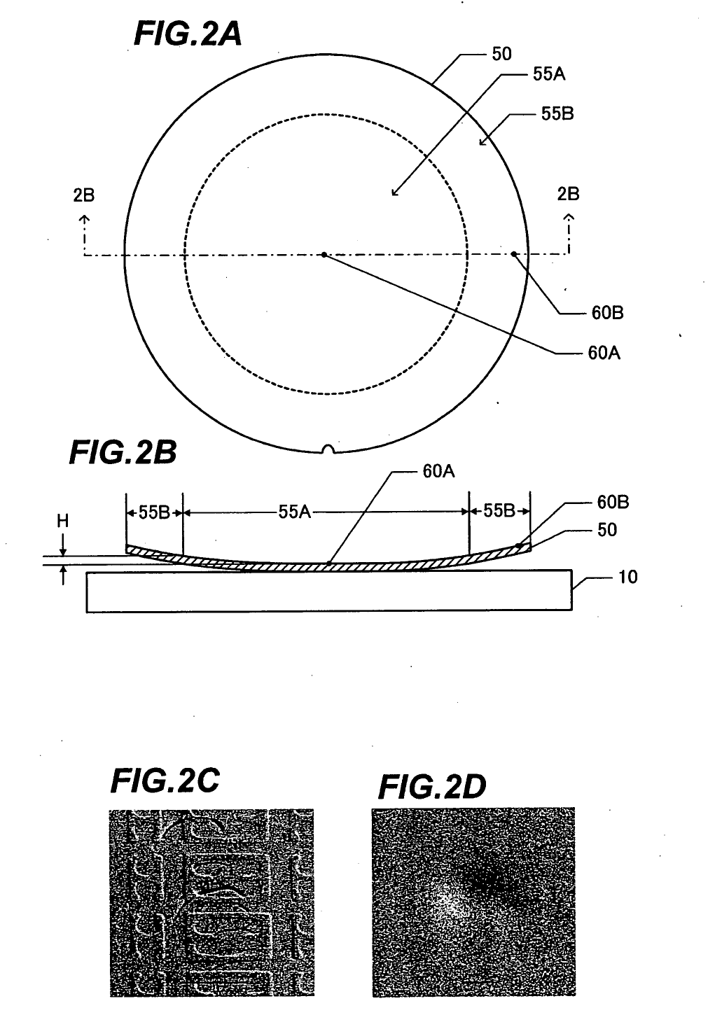

FIG. 2A is a plan view of a semiconductor wafer 50, and FIG. 2B is a cross sectional view taken along one-dot chain line 2B-2B. As shown in FIG. 2B, if the semiconductor wafer 50 has a warp, a position of a point 60A at a wafer center or near the center is different in the height direction from a point 60B near the peripheral area. The larger the diameter of the semiconductor wafer 50 is, the larger the height difference is.

If the height difference becomes larger than the maximum depth in the height direction capable of auto focusing by the electron beam source 15, it is impossible to focus both the point 60A near the center and the point 60B near the peripheral area. For example, FIG. 2C shows an image taken by focusing the point 60A near the center. Even if the stage 10 is moved laterally in this state and the point 60B near the peripheral area enters the visual field, auto focusing is impossible so that only an out-of-focus image shown in FIG. 2D is obtained. With the embodiment method described in the following, clear images can be obtained at both the point 60A near the center and the point 60B near the peripheral area.

Description will continue reverting to FIG. 1. The controller 25 transmits a control signal to the image controller 17 to take images of defects on the surface of the semiconductor wafer 50 under one imaging condition selected from a plurality of imaging conditions. The imaging conditions include an acceleration voltage Vacc of an electron beam, a probe current IP, a tilt angle θ of the stage 10 and the like. The tilt angle θ is equal to an incidence angle of the electron beam upon the semiconductor wafer 50.

In order to acquire an optimized image, the adjustment mechanism 18 performs an optical axis adjustment, particularly, column and boresight adjustments. The controller 25 is provided with an adjustment date storage device 25a.

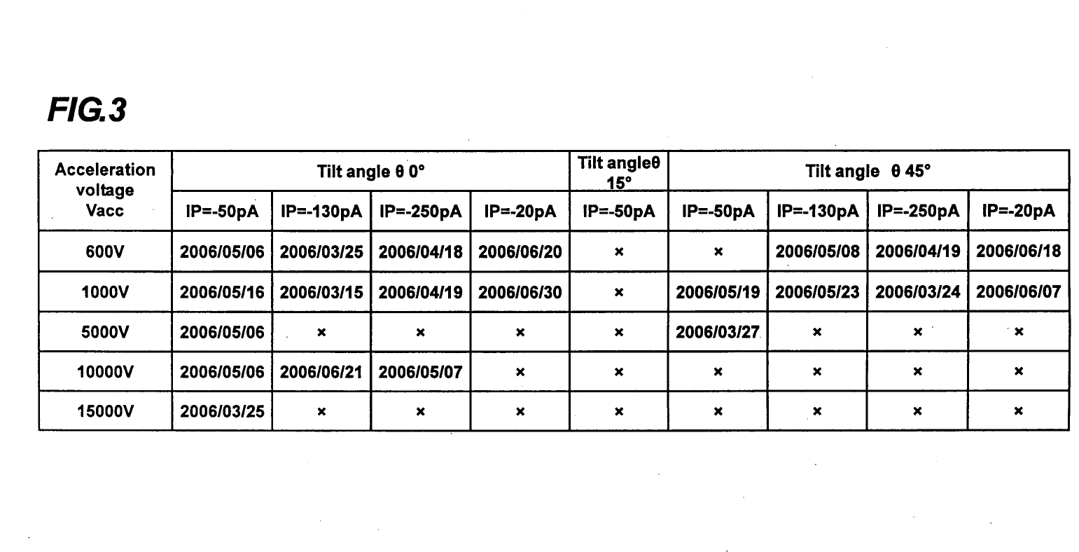

FIG. 3 shows items stored in the adjustment date storage device 25a. The date (year, month, day) when the optical axis adjustment was performed is stored in correspondence with each imaging condition constituted of a combination of the acceleration voltage Vacc of an electron beam, tilt angle θ and probe current IP. A cross mark in FIG. 3 indicates the imaging condition under which the optical axis adjustment is still not performed. For example, the optical axis adjustment was performed on May 6, 2006 under the imaging condition of an acceleration voltage Vacc of 1000 V, a tilt angle θ of 0° and a probe current IP of −50 pA.

Description will continue reverting to FIG. 1. The ADR/ADC server 41 performs auto defect review (ADR) and auto defect classification (ADC) in accordance with the images of defects acquired by the controller 25. In FIG. 1, although the ADR/ADC server 41 and controller 25 are constituted of discrete hardware, both may be constituted of a single hardware component. The function of the ADR/ADC server 41 will be described.

The ADR/ADC server 41 acquires images of defects from the controller 25, and performs automatic image recognition to make a database of images of defects. If images of defects are out-of-focus, the automatic image recognition is impossible. When automatic image recognition is performed for a plurality of defects on one semiconductor wafer 50, the ADR/ADC server 41 calculates an image recognition rate. The image recognition rate is a value obtained by dividing the number of defects capable of automatic image recognition by a total number of defects.

The ADR/ADC server 41 analyzes images of defects stored in a database, in accordance with an image recognition rule determined beforehand, and classifies defects with respect to each of defect generation causes. Defect classification results are used by a yield conservation system 42 or the like to study and analyze defect generation causes. The image recognition rule is defined with respect to each product type and each process.

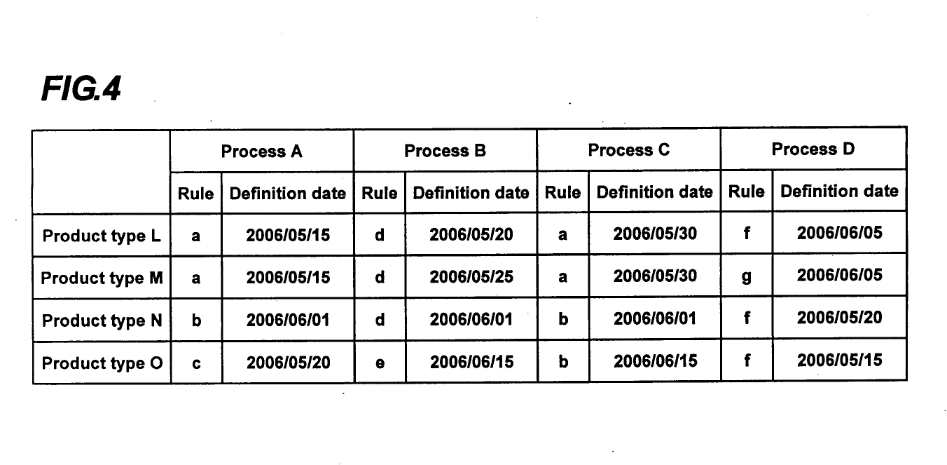

FIG. 4 shows an example of an image recognition rule table defining image recognition rules. Each image recognition rule and its definition date are related to each combination of a product type and a process. In the example shown in FIG. 4, it can be seen that an image recognition rule d is adopted for inspecting a process B for a product type M and the rule was defined on May 25, 2006.

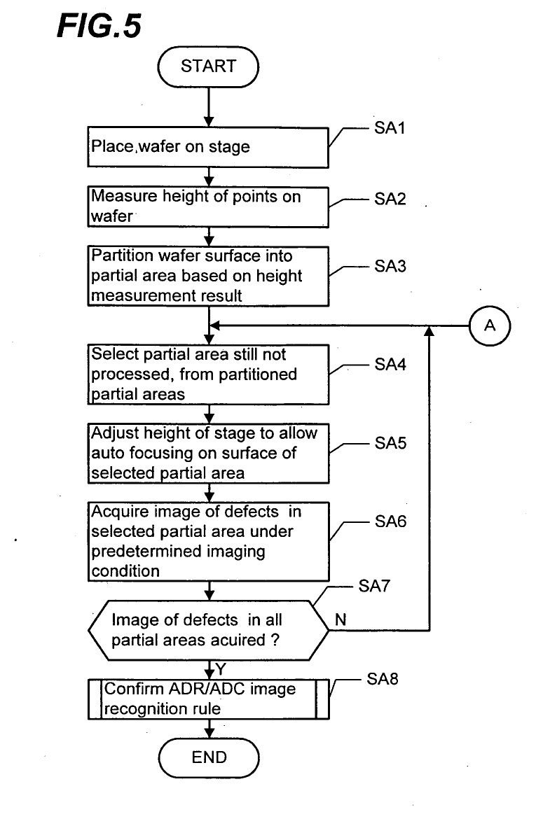

FIG. 5 is a flow chart illustrating a defect inspection method according to the embodiment. In the following, description will be made on the embodiment defect inspection method with reference also to FIGS. 1 to 4.

At Step SA1, a semiconductor wafer 50 is placed on the stage 10 in a sample chamber 1 via the load lock chamber 2 and gate valve 3. A wafer coordinate system defined on the semiconductor wafer 50 and a stage coordinate system defined on the stage 10 are correlated with each other. With this correlation, it becomes possible to move the stage 10 and move an optional point on the surface of the semiconductor wafer 50 to a desired position. The inside of the sample chamber 1 has been evacuated.

At Step SA2, the positions in the height direction of a plurality of points on the surface of the semiconductor wafer 50 are measured. This measurement is performed by focusing the optical microscope 20 on a pattern formed on the surface of the semiconductor wafer 50. By using the electron beam source 15 and secondary electron detector 16, an electron beam may be focused on the pattern on the wafer surface to measure the position in the height direction of each point.

The semiconductor wafer 50 is generally warped in such a manner that the semiconductor wafer surface is an inner side as shown in FIGS. 2A and 2B, or conversely in such a manner that the surface is an outer side. If the central surface is warped in such a manner that it is the inner side, the point 60B near the peripheral area is positioned higher than the point 60A near the center. Conversely, if the central surface is warped in such a manner that it is the outer side, the point 60B near the peripheral area is positioned lower than the point 60A near the center.

In either case, points at the same height are not distributed randomly, but when drawing contour lines on the surface of the semiconductor wafer 50, the contour lines have a shape near concentric circles. It is therefore possible to predict the position in the height direction of each point on the surface of the semiconductor wafer 50, by sampling, as measurement target points, a point at a center or near the center and a plurality of points distributed near the peripheral area and uniformly along the circumferential direction.

At Step SA3, in accordance with the positions in the height direction of points measured at Step SA2, the surface of the semiconductor wafer 50 is partitioned into a plurality of partial areas. In this case, a height difference between a point at the highest position and a point at the lowest position in each partial area, i.e., a size in the height direction of each partial area, is set equal to or shallower then the maximum depth capable of auto focusing by the imaging apparatus 30. For example, as shown in FIG. 2A, the surface is partitioned into a circular partial area 55A including the center and an outer annular partial area 55B. This partition is made in such a manner that a size H in the height direction of the partial area 55A is equal to or smaller than the maximum depth capable of auto focusing by the imaging apparatus 30. If the semiconductor wafer 50 has a large warpage, the wafer surface may be partitioned into three or more partial areas.

At Step SA4, one partial area still not processed is selected from a plurality of partitioned partial areas. Since all partial areas are not still processed initially, an optional partial area is selected. For example, in FIG. 2A the partial area 55A in the central area is selected.

At Step SA5, a height of the stage 10 is adjusted so that all points on the surface of the selected partial area are in the range capable of auto focusing by the imaging apparatus 30.

At Step SA6, images of defects in the selected partial area are taken under the predetermined imaging condition.

At Step SA7, it is judged whether images of defects in all partial areas are taken or not. If there remains a partial area, in which images of defects are still not taken, then the flow returns to Step SA4 whereat images of defects in the partial area still not processed are taken. For example, after images of defects in the central partial area 55A shown in FIG. 2A are taken, the outer partial area 55B is selected to take images of defects in the partial area 55B.

After the images of defects in all partial areas are taken, at Step SA8 auto defect review (ADR), auto defect classification (ADC), image recognition rule and the like are confirmed.

In the embodiment described above, since auto focusing is possible for any optional point in each partial area, it is possible at Step SA6 to prevent out-of-focus to be caused by the observation point locating outside the range capable of auto focusing.

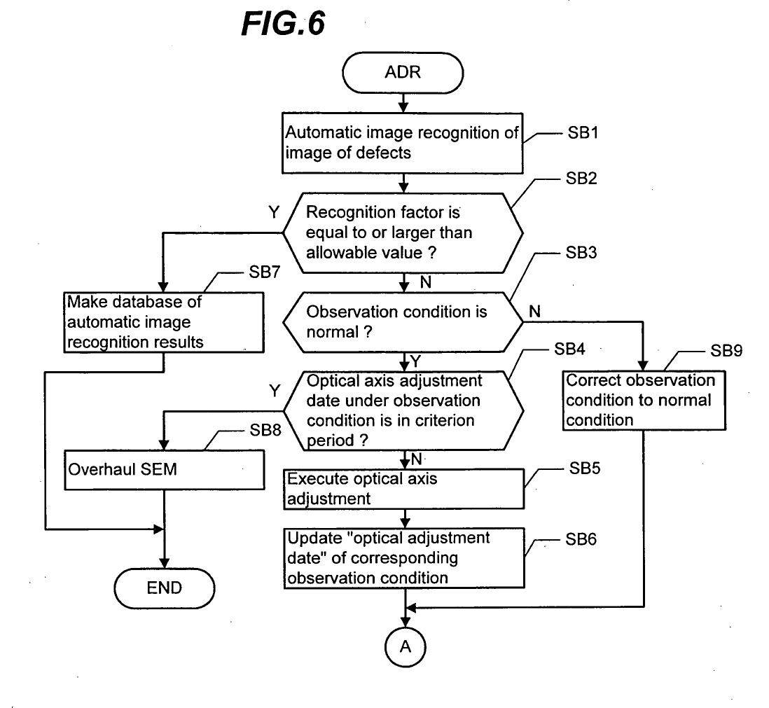

FIG. 6 is a flow chart illustrating auto defect review to be executed at Step SA8.

At Step SB1, automatic image recognition is performed for images of defects acquired at Step SA6 shown in FIG. 5, and true defects are extracted in accordance with the image recognition results and image recognition rule. As shown in FIG. 4, the image recognition rule is defined with respect to each product type and each process. An image recognition rate does not reach 100% because automatic image recognition becomes impossible due to out-of-focus and the like.

At Step SB2, it is judged whether the image recognition rate is equal to or larger than a lower allowable limit value. For example, the lower allowable limit value is set to 80%. If the image recognition rate is equal to or large than the lower allowable limit value, a database of images of defects is made at Step SB7 in accordance with the automatic image recognition results. This database is supplied to the yield conservation system 42 shown in FIG. 1 and the like.

If it is judged at Step SB2 that the image recognition rate is smaller than the lower allowable limit value, then it is judged at Step SB3 whether the imaging condition is a normal condition. The imaging condition is determined beforehand for each product type and for each process. If the imaging condition is not the normal condition, at Step SB9 the imaging condition is changed to the normal condition to thereafter return to Step SA4 shown in FIG. 5 whereat images are taken under the normal condition. In this manner, it is possible to correct a human work error.

If the imaging condition is the normal condition, then at Step SB4 the date when the optical axis was adjusted under this imaging condition is judged. As shown in FIG. 3, the date when the optical axis was adjusted is stored in the controller 25 in correspondence with the imaging condition. If the optical axis adjustment date is prior to a time point going back from the present date by a standard period, the optical axis of the imaging apparatus 30 is adjusted. The standard period is, for example, one month. The optical axis adjustment date associated with the imaging condition is updated at Step SB6. After the optical axis adjustment is completed, the flow returns to Step SA4 shown in FIG. 1 whereat images of defects are taken again. This re-imaging may be omitted for defects capable of automatic image recognition at the first imaging, and re-imaging is performed only for defects not capable of automatic image recognition at the first imaging.

If it is judged at Step SB4 that the optical axis adjustment date is not prior to a time point going back from the present date by the standard period, an apparatus failure is doubted and the imaging apparatus 30 is overhauled at Step SB8.

In the above-described auto defect review, if the image recognition rate of the automatic image recognition is low, it is possible to judge whether the optical axis adjustment of the imaging apparatus 30 is executed or the imaging apparatus 30 is overhauled, in accordance with the optical axis adjustment date stored in the adjustment date storage device 25a of the controller 25.

When auto defect classification is executed at Step SA8 shown in FIG. 5, defects are classified at Step SB1 shown in FIG. 6 with respect to each defect generation cause in accordance with a predetermined image recognition rule (defect classification rule), at the same time when the automatic image recognition is executed. Other Steps are the same as those of auto defect review.

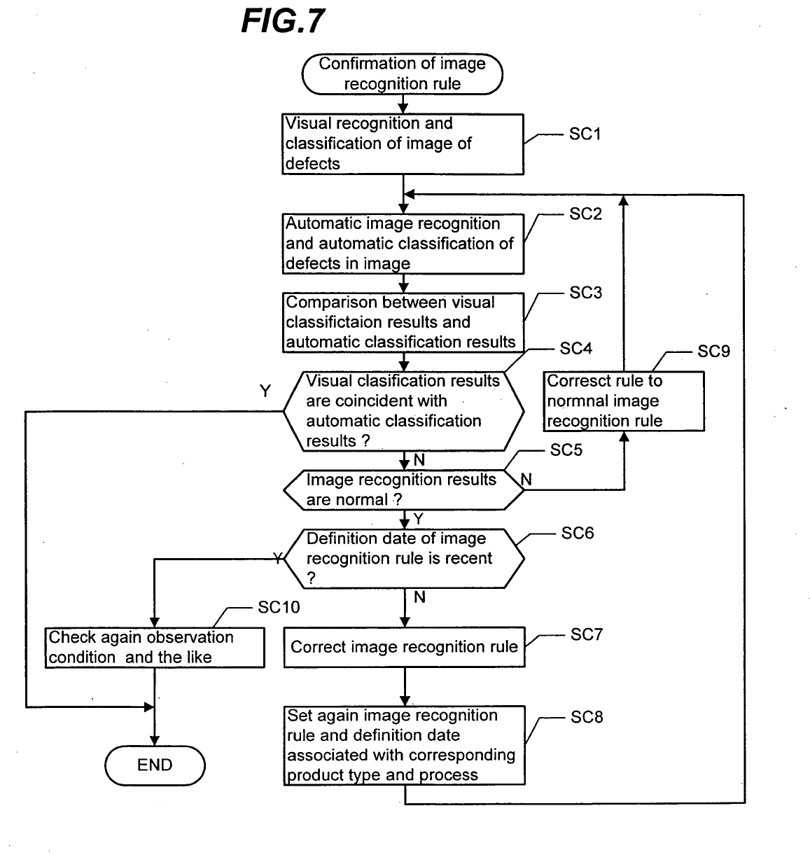

FIG. 7 is a flow chart illustrating an operation of confirming normality of the image recognition rule during the auto defect classification. At Step SC1, the images of defects are visually observed to classify the defects. At Step SC2, the images of defects are automatically recognized, and at the same time the defects are automatically classified in accordance with a predetermined image recognition rule. At Step SC3, visual classification results are compared with automatic classification results.

At Step SC4, if the classification results are coincident, it is recognized that the image recognition rule is normal, and the process is terminated. For example, if the number of defects whose classification result is different between visual classification and automatic classification is equal to or smaller than 20% of the total number of defects, it is judged that the classification results are coincident. If the classification results are incoincident, it is confirmed at Step SC5 whether the image recognition rule used is normal or not. If the image recognition rule is not a normal image recognition rule, at Step SC9 the image recognition rule is changed to the normal image recognition rule to thereafter return to Step SC2. In this manner, a human work error can be corrected.

If the image recognition rule used for automatic classification at Step SC2 is normal, it is judged at Step SC6 whether the definition date of the image recognition rule is prior to a time point going back from the present date by a standard period. The standard period is, for example, one month. As shown in FIG. 4, the definition date of the image recognition rule is recorded in the image recognition rule table. If the definition date of the image recognition rule is prior to the time point going back from the present date by the standard period, the image recognition rule is corrected and re-defined at Step SC7. Thereafter, the corrected image recognition rule and definition date are set again in the fields of the corresponding product type and process in the image recognition rule table shown in FIG. 4. The processes starting from Step SC2 are executed again by using the new image recognition rule.

If it is judged at Step SC6 that the definition date is not prior to the tome point going back from the present date by the standard period, the imaging condition and the like are revised at Step SC10.

As described above, by correcting the image recognition rule for auto defect classification at a proper time, a defect classification precision can be maintained high.

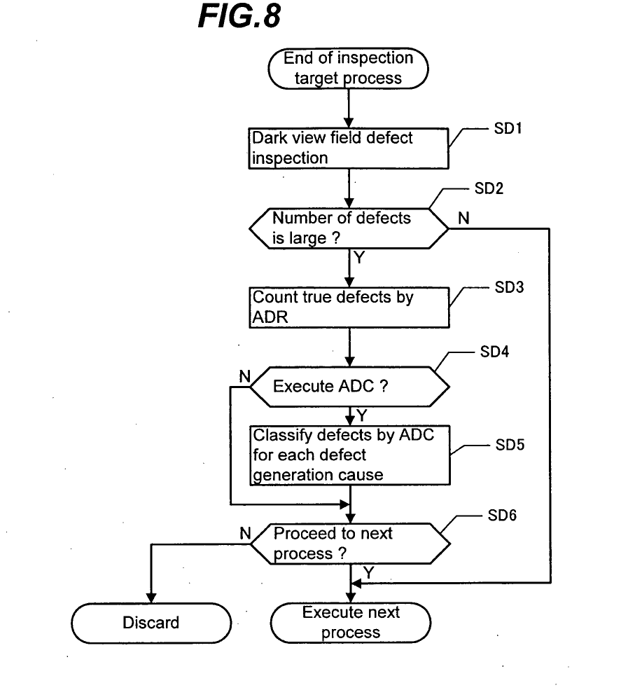

With reference to FIG. 8, description will be made on an example of execution timings of ADR and ADC of the embodiment.

As one wafer process is completed, at Step SD1 a dark view field defect inspection is executed. An inspection target process may be a shallow trench isolation (STI) forming process, a gate electrode forming process, a wiring forming process or the like. With the dark view field defect inspection, defects on a semiconductor wafer can be detected and position information on each defect can be identified.

At Step SD2, the number of defects is compared with an upper allowable limit value. If the number of defects is equal to or smaller than the upper allowable limit value, the semiconductor wafer is transported to the next process. If the number of defects exceeds the upper allowable limit value, ADR is executed at Step SD3 to count the number of true defects. This ADR is executed by the above-descried embodiment method.

In accordance with the number of true defects, it is judged at Step SD4 whether ADC is executed. If it is judged that ADC is to be executed, ADC is executed at Step SD5 to classify defects with respect to each defect generation cause. ADC is executed by the above-described embodiment method. The classification results by ADC are used when problematic processes and apparatus are identified. If it is judged at Step SD4 that ADC is not to be executed or after ADC is executed at Step SD5, it is judged at Step SD6 whether the next process proceeds. If it is judged that the next process is to proceed, the semiconductor wafer is transported to the next process, whereas if it is judged that the next process is not to proceed, the semiconductor wafer is discarded.

The present invention has been described in connection with the preferred embodiments. The invention is not limited only to the above embodiments. It will be apparent to those skilled in the art that other various modifications, improvements, combinations, and the like can be made.

What are claimed are:

1. A defect inspection method comprising steps of:
(a) preparing a semiconductor wafer whose position information on defects on a surface of the semiconductor wafer is already known;
(b) placing the semiconductor wafer on a stage of an imaging apparatus;
(c) measuring positions in a height direction of a plurality points on the surface of the semiconductor wafer;
(d) partitioning the surface into a plurality of partial areas in accordance with the positions in the height direction measured by the step (c);
(e) selecting from the partial areas one partial area for which images of defects are still not acquired;
(f) adjusting a height of the stage so as to set the selected partial area in an auto focusing range of the imaging apparatus;
(g) imaging defects in the selected partial area with the imaging apparatus to acquire images of defects; and
(h) repeating the steps (e) to (g) until images of defects in all partial areas are acquired.

2. The defect inspection method according to claim 1, wherein the imaging apparatus is a scanning electron microscope.

3. The defect inspection method according to claim 1, wherein the step (d) partitions the surface into a plurality of partial areas in such a manner that a size in the height direction of each partial area is smaller than a size capable of auto focusing by the imaging apparatus.

4. The defect inspection method according to claim 1, wherein:
the imaging apparatus acquires the images of defects by imaging defects of the semiconductor wafer under one imaging condition selected from a plurality of imaging conditions;
the imaging apparatus further comprises an adjustment mechanism for acquiring optimum images of defects under each imaging condition and an adjustment date storage device for storing a date when adjustment is performed by the adjustment mechanism, with respect to each imaging condition; and
the defect imaging method further comprises steps of:
(i) after the step (h), performing automatic image recognition for each of acquired images of defects;
(j) if an image recognition rate at the step (i) is lower than a lower allowable limit value, judging from an adjustment date associated with the imaging condition adopted in the step (g) whether adjustment by the adjustment mechanism is performed again; and
(k) if it is judged at the step (j), performing adjustment of the imaging apparatus by the adjustment mechanism and renewing the adjustment date associated with the imaging condition adopted by the step (g).

5. The defect inspection method according to claim 1, further comprising, after the step (h), steps of:
(o) classifying a plurality of defects by visually observing the acquired images of defects;
(p) automatically classifying the plurality of defects through automatic recognition of the acquired images of detects in accordance with an image recognition rule; and
(q) comparing a result classified at the step (o) with a result classified at the step (p), and if an error between the results is outside an allowable range, correcting the image recognition rule to define again the image recognition, and thereafter executing again the step (p).

6. A defect inspection apparatus comprising:
a stage provided with a function of placing a semiconductor wafer thereon and displacing the placed semiconductor wafer in a height direction;
a height measuring device for measuring positions in the height direction of a plurality of points on a surface of the semiconductor wafer placed on the stage;
an imaging device for automatically focusing on a point positioned in an auto focusing range in the height direction and imaging defects on the surface of the semiconductor wafer placed on the stage to acquire images of defects; and
a controller storing position information on a plurality of defects on the surface of the semiconductor wafer placed on the stage,
wherein the controller controls the stage and the imaging device so as to execute steps of:
(a) partitioning the surface of the semiconductor wafer into a plurality of partial areas in accordance with positions in the height direction of the surface of the semiconductor wafer placed on the stage;
(b) selecting from the partial areas one partial area for which images of defects are still not acquired;
(c) adjusting a height of the stage so as to set the selected partial area in an auto focusing range of the imaging device;
(d) acquiring images of defects in the selected partial area with the imaging device; and
(e) repeating the steps (b) to (d) until images of defects in all partial areas are acquired.

7. A defect inspection apparatus according to claim 6, wherein the imaging device is a scanning electron microscope.

8. The defect inspection apparatus according to claim 6, wherein the step (a) partitions the surface into a plurality of partial areas in such a manner that a size in the height direction of each partial area is smaller than a size capable of auto focusing by the imaging device.

9. The defect inspection apparatus according to claim 6, wherein:
the imaging device includes an adjustment mechanism for selecting one imaging condition from a plurality of imaging conditions, observing defects on the semiconductor wafer under the selected imaging condition, and acquiring images of defects to acquire optimum images of defects under each imaging condition; and
the controller includes an adjustment date storage device for storing a date when adjustment is performed by the adjustment mechanism, with respect to each imaging condition, wherein the controller performs automatic image recognition of the images of defects acquired by the imaging device and calculates an image recognition rate.
